(19) United States
(12) Patent Application Publication
(10) Pub. No.: US 2024/0394285 A1
(43) Pub. Date: Nov. 28, 2024

(54) Chatbot

(71) Applicant: Sage Global Services Limited, Newcastle upon Tyne (GB)

(72) Inventors: Ben Cunningham, Warren, NJ (US); David Loving, Moore, OK (US); Jordan Earnest, San Francisco, CA (US); Srijith Rajamohan, Crozet, VA (US); Yu-Cheng Tsai, Redmond, WA (US)

(73) Assignee: Sage Global Services Limited, Newcastle upon Tyne (GB)

(21) Appl. No.: 18/670,380

(22) Filed: May 21, 2024

Related U.S. Application Data
(60) Provisional application No. 63/468,129, filed on May 22, 2023.
(60) Provisional application No. 63/537,272, filed on Sep. 8, 2023.

(51) Int. Cl. G06F 16/332; G06F 16/33; H04L 51/02

(52) U.S. Cl. CPC G06F 16/3329; G06F 16/3344; H04L 51/02

(57) ABSTRACT

A computer-implemented chatbot including a prompt generation module, a large language model (LLM) module, and an answer generation module. The prompt generation modules generates an initial prompt based on a prompt template combined with a received user query. The initial prompt includes information source data specifying sources of factual information, conversation history data, and failed response data. The initial prompt is input to the LLM module, which is configured to generate an output and communicate the output to the answer generation module. The answer generation modules determines if the output is a plan to answer a user query. If so, relevant data is retrieved from external database or more APIs specified in the information source data. A further prompt is generated for answering the user query and input to the LLM module. The answer generation module repeats its tasks until a suitable answer to the user query is output.

### CROSS REFERENCE TO RELATED APPLICATIONS

This application claims priority to and the benefit of U.S. Provisional Patent Application No. 63/468,129, filed on May 22, 2023, entitled “GENERATIVE AI”, and U.S. Provisional Patent Application No. 63/537,272, filed on Sep. 8, 2023, and entitled “GENERATIVE AI”, the contents of each of which are incorporated herein by reference as though fully set forth herein.

### TECHNICAL FIELD

The present invention relates to technique for implementing AI-based chatbots.

### BACKGROUND

AI-based “chatbots”, configured to respond to user input (usually text) with a natural language response, have been available for some time. However, with recent advances in AI capability, in particular advances in LLM-based systems, such as the GPT-3.5 and GPT-4 models created by OpenAI, and the LLaMa model created by Meta, the ability of chatbots to answer queries and undertake reasoning-based tasks have greatly improved.

Increasingly, chatbots can serve as valuable tools to aid individuals in executing their job responsibilities particular in performing tasks involving a text generation, grammar and style correction, answering simple factual queries and so on. As the models that underpin many of these chatbots become larger and more sophisticated, they can also assist with simple reasoning and decision making. However, their ability to provide useful support to individuals performing roles that require processing large amounts of data to make high-level decisions, such as strategic investments or hiring, remains limited.

The existing technology for AI chatbots operates based on a defined set of instructions and pre-programmed responses. These systems are adept at answering simple queries or performing tasks with clear, step-by-step procedures. However, when it comes to handling tasks that are complex, high-level, or multifaceted, traditional chatbots often struggle.

One of the notable shortcomings of these conventional AI chatbots is their inability to autonomously handle high-level tasks. These tasks, which are common in the roles of executives like CFOs, require not just a higher degree of understanding, but also the ability to break down a larger task into smaller, more manageable parts. Furthermore, these AI chatbots have limited capacity to access complex factual information from various databases. A CFO, for example, might need a system that can access information from a variety of financial databases, synthesize this information, and then apply it to a specific task. This is not something that conventional AI chatbots are designed to handle.

Despite these limitations, chatbots provide a useful and highly intuitive interface enabling human beings to clarify their thinking and reach solutions to problems. Accordingly, it would be desirable to provide a technical architecture enabling an AI-chat bolt to be provided that would be suitable for individuals making high level decisions whilst taking into account large amounts of information.

### SUMMARY

In accordance with the first aspect of the invention there is provided a computer-implemented chatbot comprising: a prompt generation module; a large language model (LLM) module and an answer generation module, wherein said prompt generation module is configured to: generate an initial prompt based on a prompt template combined with a received user query, said initial prompt including information source data specifying one or more sources of factual information, said sources comprising one or more external databases and/or one or more APIs, conversation history data comprising information specifying a conversation history, and failed response data indicative of previous prompts which have failed to produce a satisfactory response; and input the initial prompt to the LLM module, wherein the LLM module is configured to generate an output and communicate the output to the answer generation module, responsive to which, the answer generation module is configured to:
a) determine if the output is a plan to answer a user query, and if so,
   retrieve relevant data from the one or more external database and/or one or more APIs specified in the information source data;
b) generate a further prompt for answering the user query and input the further prompt to the LLM module;
c) repeat a) and b) until the output of the LLM module provides a suitable answer to the user query, then
   output the answer to the user query.

Optionally, wherein the answer generation module is configured to determine if an answer to the user query is a suitable answer by generating a suitable-answer-assessment prompt including: the answer, the initial user query, and an instruction for the LLM to determine if the answer is a suitable answer, said answer generation module configured to determine that the answer is a suitable answer if the LLM module outputs a response to the suitable-answer-assessment prompt indicating that the answer is a suitable answer.

Optionally, each time the LLM module generates an output which is a plan to answer the user query, the answer generation module is configured to execute a self-critiquing process, whereby a critique-request instruction prompt is generated and input to the LLM module instructing the LLM module to determine if the output meets a suitability criteria, and if the LLM module generates an output indicative of the output not meeting the suitability criteria, the answer generation module is configured to perform a corrective action.

Optionally, the corrective action comprises restarting by inputting the initial prompt to the LLM module.

Optionally, the corrective action comprises generating an output indicating the user query has not been answered.

Optionally, the initial prompt generated by the prompt generation module includes an instruction for the LLM to generate a plan to answer the user query if necessary.

Optionally, the one or more APIs provide access to an internet search engine.

In accordance with the second aspect of there is provided a method of generating a response using a computer-implemented chatbot, said method comprising: generating an initial prompt based on a prompt template combined with a received user query, said prompt including information source data specifying one or more sources of factual information, said sources comprising one or more external databases and/or one or more APIs, conversation history data comprising information specifying a conversation history, and failed response data indicative of previous prompts which have failed to produce a satisfactory response; inputting the initial prompt to a LLM to generate an output; determining if the output is a plan to answer a user query, and if so,
a) retrieving relevant data from the one or more external database and/or one or more APIs specified in the information source data,
b) generating a further prompt for answering the user query and input the further prompt to the LLM;
c) repeating a) and b) until the output of the LLM provides a suitable response to the user query, then outputting the response to the user query.

Optionally, the method further comprises determining if an answer to the user query is a suitable answer by: generating a suitable-answer-assessment prompt including: the answer, the initial user query and an instruction for the LLM to determine if the answer is a suitable answer or not, and determining that the answer is a suitable answer if the LLM outputs a response to the prompt indicating the answer is a suitable answer.

Optionally, the method further comprises, each time an output is generated which is a plan to answer the user query, executing a self-critiquing process, comprising: generating a critique-request instruction prompt instructing the LLM to determine if the output meets a suitability criteria; inputting the critique-request instruction prompt to the LLM, and if, the LLM generates an output indicative of the output not meeting the suitability criteria, performing a corrective action.

Optionally, wherein the corrective action comprises restarting the process by inputting the initial prompt to the LLM.

Optionally, wherein the corrective action comprises generating an output indicating the user query has not been answered.

Optionally, wherein the initial prompt includes an instruction for the LLM to generate a plan to answer the user query if necessary.

Optionally, wherein the one or more APIs provide access to an internet search engine.

In accordance with a third aspect of the invention there is provided a computer program providing instructions which when implemented on a computing device implements a method according the second aspect of the invention.

In accordance with certain embodiments of the invention, a computer implemented AI-based chat bot is provided which includes a prompt generation module and an answer generation module. The prompt generation module is configured to receive a user query and based on a prompt template, generate a prompt for an LLM. This includes an instruction to answer the user query. The prompt, thus generated, includes data specifying sources of factual information, conversation history data, and data related to previously generated responses which have failed to produce a satisfactory response. This prompt is input to an LLM, which generates a response that is input into an answer generation module.

The answer generation module is configured to determine if the output from the LLM is an answer to the user query or provides a plan to answer the user query. If it is a plan to answer the user query, this plan is then formulated as a further LLM prompt, including, where needed, information drawn from suitable sources, which the answer generation module passes through the LLM. This process iterates until the answer generation module judges that a suitable answer is produced to the user query.

These features give rise to an AI chatbot that is more responsive, adaptable, and efficient in dealing with complex queries. The chatbot's prompt generation module allows it to draw from a wider variety of data sources and take into account conversation history and past failures, making it more capable of dealing with complex or context-specific queries. The answer generation module, with its iterative interaction with the LLM module and the data sources, ensures the production of a more suitable response to user queries. Importantly, by virtue of the answer generation module's access to factual information, the chance of hallucination is reduced, making the response more trustworthy The combination of these two features leads to a more effective chatbot, particularly in roles requiring complex problem-solving and information processing.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram depicting a system for implementing an AI-based chatbot in accordance with certain embodiments of the invention;

FIG. 2 provides a flow diagram depicting a process for generating an output to a user query using an AI-based chatbot of the type described with reference to FIG. 1, and

FIG. 3 provides a simplified schematic diagram depicting an example implementation of a system for implementing an AI-based chatbot in accordance with certain examples of the invention.

### DETAILED DESCRIPTION

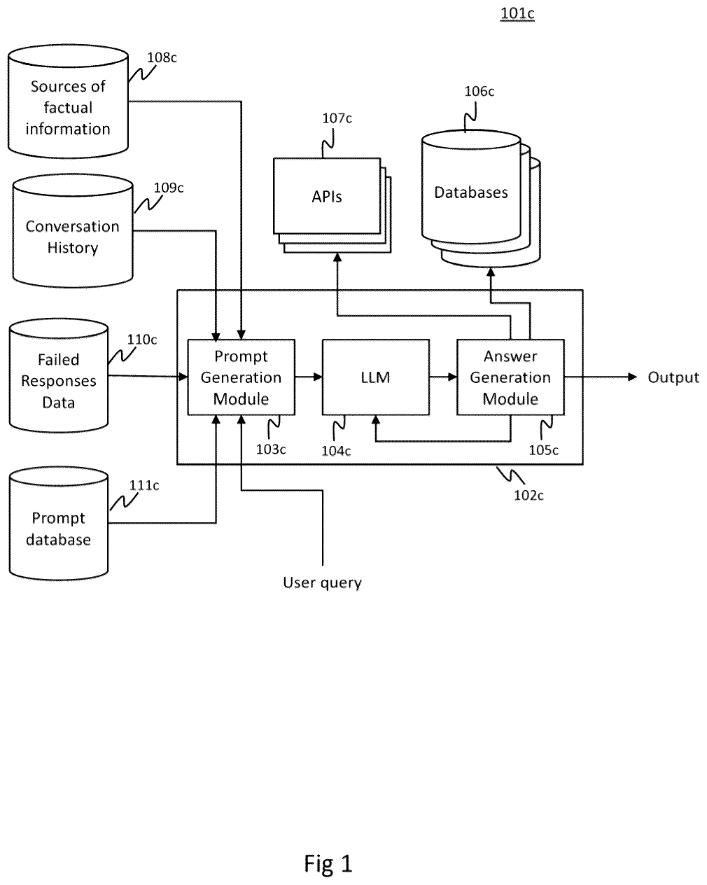

FIG. 1 provides a simplified schematic diagram depicting a computer system 101c for implementing an AI-based chatbot 102c optimised for individuals, for example CFOs, who require answers to their queries to be based on factual information. In addition, the chatbot offers an important feature that allows CFOs to query factual information “on demand”. CFOs can obtain real-time, up-to-date analysis through natural and interactive conversation. The chatbot acts as a professional data analysis assistant.

The chatbot 102c includes a prompt generation module 103c, an LLM module 104c and an answer generation module 105c. The prompt generation module 103c is connected to the LLM module 104c which is connected to the answer generation module 105c. The answer generation module 105c is further connected to a plurality of external databases 106c, for example relevant SQL/NoSQL database, embedding/vector store databases, graph databases and so on, and to a plurality of APIs 107c providing interfaces to a plurality of external third-party systems for example a search engine.

The prompt generation module 103c is connected to a sources-of-factual-information database 108c which provides a summary of the information available to the chatbot 102c via the plurality of external databases 106c and plurality of APIs 107c, a conversation history database 109c containing data indicative of a conversation history between the chatbot 102c and a user; a failed responses data database 110c containing data indicative of prompts which have failed to produce a desirable output, and a prompt data database 111c containing pre-engineered prompt templates for generating prompts for the LLM module 104c. The prompt generation module 103c is also configured to receive a user query from the user.

In use, the prompt generation module 103c is configured to generate an initial prompt for the LLM module 104c which is then processed by the LLM module 104c and output to the answer generation module 105c.

In typical examples, the user query may be a query which requires the chatbot 102c to undertake a task involving reasoning and the processing of certain factual information and generate a response based on this factual information. For example, example queries may be: “What is my forecast for ending balance?”; “Recommend the top 3 vendors who are going to pay early so that I can maximize my cashflow”, and “I've been thinking about growing my sales team. When do you think I should hire my next sales rep?”

Based on a received user query, the prompt generation module 103c generates an initial prompt for passing to the LLM module 104c. The initial prompt is typically based on a pre-engineered prompt template from the prompt data database 111c. This pre-engineered prompt template typically includes input to be included with a prompt including: data from the sources-of-factual-information database 108c indicating sources of the factual information available to the chatbot 102c; conversation history data extracted from the conversation history database 109c, and failed response data providing examples of failed responses from the failed responses data database 110c.

An example of the pre-engineered prompt template might include text such as:
“As an intelligent large language model agent system, my task is to solve users' tasks using the provided tools. If I don't know the answer, I will say “I don't know.” I can learn from my previous mistakes and self-reflect to produce a better plan. I will use the conversation history to make the conversation coherent. The list of tools includes API URLs, SQL tables, and a summary of facts. The conversation history is also provided. Finally, I will review the past failed plan of execution procedure to produce a better plan for execution.”

The pre-engineered prompt-template might also typically include instructions for the LLM module 104c to produce a plan to answer the user query, rather than answer the user query in a single pass, if this is necessary. For example, the prompt may specify that it is necessary to produce a plan to answer the user query if the user query is a complex one (for example requiring multiple stages of reasoning to be performed) and/or is a query requiring further information from the further sources of factual information, for example requiring data from the databases or data

Accordingly, the initial prompt, generated by the prompt generation module 103c combining the user query with the pre-engineered prompt-template, might typically be a prompt for the LLM module 104c to generate a plan to answer the user query using only the factual information from the sources of factual information indicated in the sources-of-factual-information database 108c, taking into account the context provided by the conversation history data from the conversation history database 109c and examples of failed responses from the failed responses data database 110c.

Responsive to receipt of this prompt, the LLM module 104c generates an output which is communicated to the answer generation module 105c. If the user query was a complex one and/or one requiring further information, rather than a simple query that could be answered immediately, the output from the LLM module 104c will typically be text data setting out a plan to answer the query.

For example, output text could outline a plan comprising a series of steps, which when performed, will address the user query. The output text data may also specify which data to retrieve and from which sources. In certain examples, one or more of the steps in the plan may direct the formation of further sub plans, in other words meaning that one or more further plans need to be made before the user query can be addressed.

Responsive to receipt of such an output, the answer generation module 105c is configured to retrieve any data necessary to implement the plan and then construct a further prompt including this data and the text data specifying the plan which was output in response to the initial prompt. The answer generation module 105c then feeds this prompt back into the LLM module 104c, including relevant data extracted from the plurality of external databases 106c and obtained from the plurality of APIs 107c. This then generates another output which is fed into the answer generation module 105c.

This cycle can continue until the answer generation module 105c determines that a suitable answer to the initial user query has been generated, which is then output.

The answer generation module 105c can determine that an answer is “suitable” in any appropriate way. In one example, this is achieved by formulating a further prompt instructing the LLM module 104c to assess the suitability of the generated answer. In one example, the answer generation module 105c is configured to generate a prompt (a suitable-answer-assessment prompt) including the final answer to the user query, the initial user query, and an instruction for the LLM module 104c to determine if the answer is a suitable answer. The instruction may specify that the LLM should determine that whether the answer is suitable and provide an indicative output which is one of either “suitable” or “not suitable” (i.e. constraining the LLM to provide a binary output). This suitable-answer-assessment prompt is then passed through the LLM module 104c, and the answer deemed suitable if the LLM module 104c produces an output indicating that the answer to the user query is suitable.

In another example, the answer generation module 105c can use alternative or additional techniques to determine that an answer is suitable. For example, the answer generation module 105c can employ traditional machine learning metrics to judge the quality of the answer. Depending on the type of task, different metrics can be applied. For a classification task, metrics such as F1 score, precision, and recall can be used. For regression tasks, where numerical values are predicted, the root mean square error can be employed. In recommendation tasks, a similarity score might be used.

In the event that the LLM module 104c outputs an answer indicating that the answer is not suitable, then the answer generation module 105c can generate a suitable output. More specifically, the answer generation module 105c can initiate an error process and output an error, for example a message specifying “Query not answered, please try again”.

In certain examples, each time the LLM module 104c generates an output that isn't the final answer to the user query, a “self-critiquing” process can be performed where the output is evaluated by being passed back through the LLM module 104c with an instruction to critique whether or not the output amounts to a suitable response to the query given the input prompt that resulted in its generation.

For example, each time the LLM module 104c generates an output providing a plan to answer a user query along with a requirement for certain data to be retrieved to implement the plan, this output and the prompt which generated it are used to generate a critique-request prompt which instructs the LLM module 104c to analyse whether or not the output (the plan) was an appropriate response given the previous input (the initial user query or the previous plan output). The critique-request prompt can include a suitability criterion against which the output is assessed. For example, the suitability criterion can be a simple binary evaluation of ‘relevant’ or ‘irrelevant.’ This criterion instructs the LLM module 104c to assess whether the output (the plan to answer the query and the required data retrieval) directly addresses the input prompt (the user's query). The output is considered ‘relevant’ if it effectively tackles the user's query and ‘irrelevant’ if it fails to do so.

If the answer generation module 105c determines that a suitable response has not been generated at any point, it can be configured to take appropriate corrective action, for example to restart the process entirely be inputting the initial prompt back into the LLM module 104c. Alternatively, the answer generation module can generate an output a message stating “unable to answer query”.

On the other hand, if the answer generation module 105c determines that a suitable response has been generated, the process continues as described above.

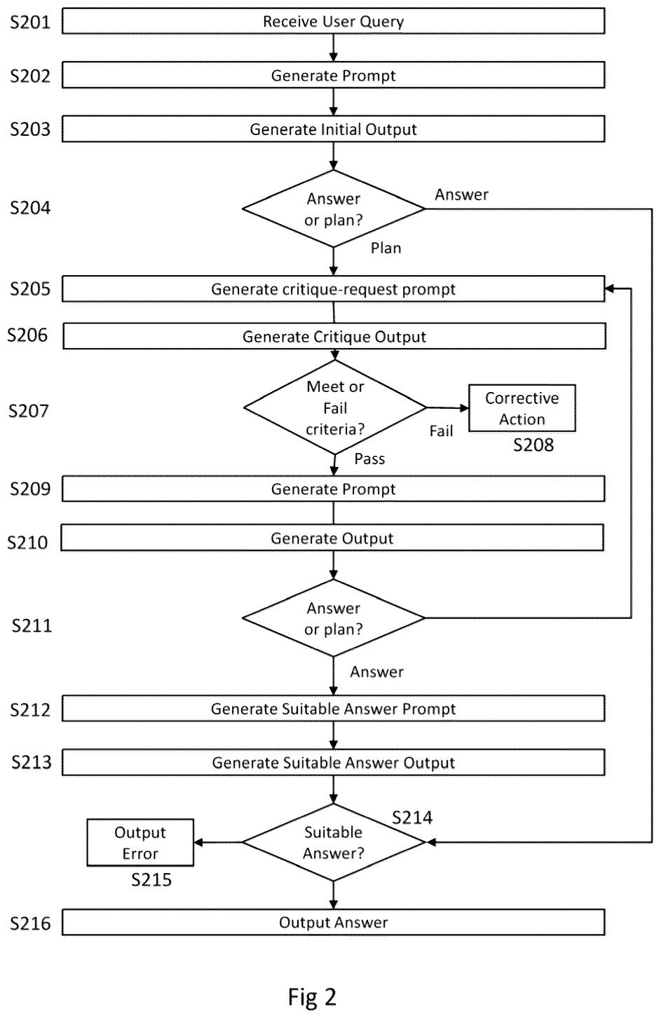

FIG. 2 provides a flow diagram depicting a process for generating an output to a user query using an AI based chatbot of the type described with reference to FIG. 1.

At a first step S201, a user query is received. At a second step S202, a prompt is generated using the user query and a prompt template.

At a third step S203, the prompt is passed through an LLM module 104c and an initial output generated.

At a fourth step S204, this initial output is assessed to determine whether or not the output is an answer to the user query, or a plan to answer the user query. At a fifth step S205, if at the fourth step S204 it is determined that the initial output it is a plan to answer the user query, a critique-request prompt is generated comprising instructions to determine if the plan meets a suitability criterion.

On the other hand, if at the fourth step S204 it is determined that the initial output an answer to the user query, then the process proceeds to the fourteenth step S214 described in more detail below.

Returning to the process flow, at the fifth step S205 where a critique prompt is generated, the process proceeds to a sixth step S206 where the critique prompt generated at the fifth step S205 is input to the LLM module 104c, and a critique output generated.

At a seventh step S207, it is determined whether or not the critique output is indicative of the plan to answer the user query meeting or failing to meet the suitability criteria. If this is not the case, then at an eighth step S208, corrective action is taken. For example, the process can be restarted, for example the process can return to the second step S202, or an error can be output indicating that the user query has not been answered.

On the other hand, if it is determined that the critique output is indicative of the plan to answer the user query meeting the suitability criteria, at a ninth step S209, the plan generated at the third stage S203 is used to formulate a prompt to implement the plan and this prompt input to the LLM module 104c.

At a tenth step S210, this prompt is passed through the LLM module 104c and an output generated. At an eleventh step S211, the output generated by the LLM module 104c is assessed to determine whether or not it is an answer to the user query or a plan to answer the user query. If it is determined that the output generated at the tenth step S210 is an answer to the user query, then at a twelfth step S212, an answer suitability prompt is generated instructing the LLM module 104c to determine if the answer to the user query that has been generated is a suitable answer.

On the other hand, if it is determined that the output generated at the tenth step S210 is a plan to answer the user query, then the process returns to the fifth step S205.

At a thirteenth step S213, this prompt is input to the LLM module 104c, and answer is output indicating whether or not the LLM has determined that the answer output at the tenth step S210 is a suitable answer.

If, at a fourteenth step S214, it is determined that the answer is not a suitable answer, then at a fifteenth step S215, an error process is initiated. On the other hand, if at the fourteenth step it is determined that the answer is a suitable answer, then at a sixteenth step S216, the answer is output.

Returning to FIG. 1, the skilled person will understand that the various components of the system 101c for implementing the AI chatbot, including the prompt generation module 103c, LLM module 104c and answer generation module 105c, can be implemented in any suitable way.

The skilled person will understand that these components can be implemented as a single application or in various other ways, such as separate modules, combined modules, distributed services, or in any other suitable configuration.

The components shown in FIG. 1, whether implemented as a single application or otherwise, can run locally or remotely on a single physical server or can be distributed across servers using cloud computing. Furthermore, the components shown in FIG. 1, whether implemented as a single application or otherwise, can be carried out in any suitable environment, such as a ‘serverless’ environment, a traditional on-premises server, a virtual machine, a containerised environment (such as Docker), a Platform-as-a-Service (PaaS) environment, a fully managed cloud service, or any other appropriate environment that meets the system's requirements.

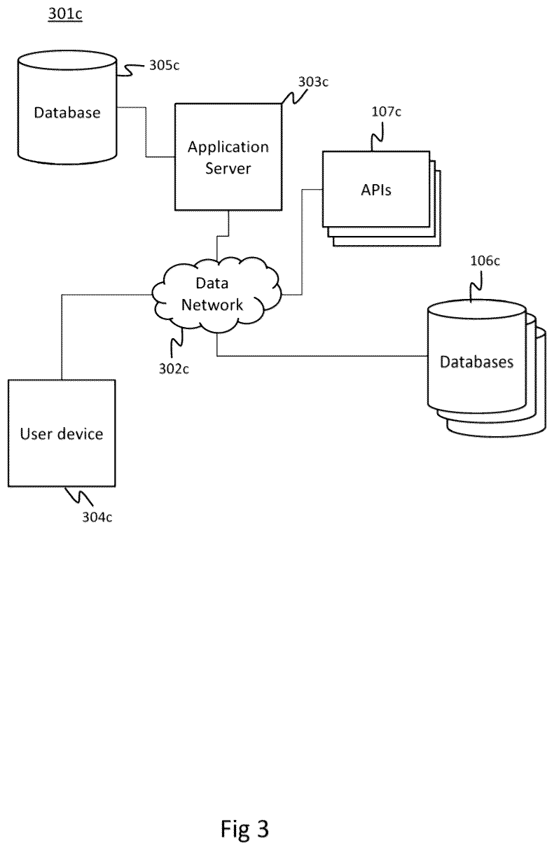

FIG. 3 provides a simplified schematic diagram depicting an example implementation of a system for implementing an AI-based chatbot in accordance with certain examples of the invention.

The arrangement comprises a computer system 301c which includes the external databases 106 and plurality of APIs 107c connected via a data network 302c, typically a suitable data network such as the Internet, to an application server 303c. A user device 304c, which could be any suitable user device such as a smartphone, tablet, or desktop computer, is also connected to the data network 302c. The application server 303c is further connected to data storage provided by a database system 305c.

The user device 304c has running thereon software that serves a web page to software running on the user device 304c that provides an interface via which the user query can be provided by a user of the user device 304c and via which the output generated by the answer generation module 105c can be displayed to the user. The application server 303c has running thereon software that implements the chatbot 102c, and in particular the prompt generation module 103c, LLM module 104c and answer generation module 105c.

In certain examples, the LLM module 104c can provide an LLM which runs locally on the application server 303c. In other examples, the LLM module 104c can provide access (for example via the data network 302c) to an LLM run remotely on a different server, provided, for example, by a third party.

The sources-of-factual-information database 108c, conversation history database 109c, failed responses data database 110c and prompt data database 111c can be implemented on the database system 305c. The database system 305c can be provided by any suitable arrangement as is known in the art, for example, it could consist of relational or NoSQL databases tailored to the system's specific needs. These databases could be hosted either on-premises or in the cloud, using either open-source or proprietary database management systems.

The skilled person will understand that the LLM module 104c is an abstraction representing complex data processing functionalities. These include the process of receiving human-readable prompts and converting them through tokenisation into a numerical format suitable for the neural network. The input then passes through the network's layers, involving various mechanisms like attention and activation functions, based on the specific architectural configuration. The output is interpreted and decoded back into a human-readable form, making use of components for preprocessing and postprocessing within the LLMs. The prompt-template generating LLM 104 can be implemented using conventional, generally trained LLMs or may be specifically trained to generate candidate prompt-templates. Similarly, the prompt testing LLM 108 can be configured and trained to model the LLMs on which selected prompts will be used for a given application.

The skilled person will understand that the LLM module 104c is an abstraction representing complex data processing functionalities for implementing Large Language Models. These include data processing functionalities for receiving human-readable prompts and converting them through tokenisation into a numerical format suitable for a neural network. These further include data processing functionalities for passing the input through a network's layers, involving, for example, various mechanisms like attention and activation functions, based on the specific architectural configuration. These further include data processing functionalities for interpreting the output and decoding it back into a human-readable form, including components for preprocessing and postprocessing. The LLM module 104c can be implemented using a conventional, generally trained LLM or may be a an LLM specially trained for use in an AI chatbot.

The skilled person will understand that the term ‘LLM’ refers broadly to the class of generative AI systems capable of processing and generating text in a manner that resembles human language output. While these systems often employ machine learning techniques, specifically neural networks, the term ‘LLM’ does not restrict them to any particular methodology for understanding context or generating responses. LLMs may exhibit a range of architectures and sizes, and can be trained using various methods. The scope of ‘LLM’ is intended to encompass all generative systems that can achieve these functions, without limiting them to any specific architecture, model, or training approach.

As the skilled person will understand, systems for implementing the techniques described above can be implemented using any suitable hardware arrangement including workstations, servers, mobile devices, or embedded systems. This also includes specialized AI hardware like Graphics Processing Units (GPUs), Tensor Processing Units (TPUs), Field Programmable Gate Arrays (FPGAs), Application-Specific Integrated Circuits (ASICs), or other similar hardware suitable for machine learning tasks.

Furthermore, as the skilled person will understand, systems for implementing the techniques described above can be implemented using any suitable programming languages, such as Python, Java, C++, or others, and any suitable AI libraries like TensorFlow, PyTorch, or others. They can be executed as standalone applications, web-based applications, mobile applications, or as parts of larger software systems, or any other suitable deployment methods. The systems can also be containerised for deployment in diverse settings using technologies like Docker, Kubernetes, or similar technologies.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A computer-implemented chatbot comprising: a prompt generation module; a large language model (LLM) module and an answer generation module, wherein said prompt generation module is configured to:
generate an initial prompt based on a prompt template combined with a received user query, said initial prompt including information source data specifying one or more sources of factual information, said sources comprising one or more external databases and/or one or more APIs, conversation history data comprising information specifying a conversation history, and failed response data indicative of previous prompts which have failed to produce a satisfactory response; and
input the initial prompt to the LLM module, wherein
the LLM module is configured to generate an output and communicate the output to the answer generation module, responsive to which, the answer generation module is configured to:
a) determine if the output is a plan to answer a user query, and if so,
retrieve relevant data from the one or more external database and/or one or more APIs specified in the information source data,
b) generate a further prompt for answering the user query and input the further prompt to the LLM module,
c) repeat a) and b) until the output of the LLM module provides a suitable answer to the user query, then
output the answer to the user query.

2. A computer-implemented chatbot according to claim 1, wherein the answer generation module is configured to determine if an answer to the user query is a suitable answer by generating a suitable-answer-assessment prompt including: the answer, the initial user query, and an instruction for the LLM to determine if the answer is a suitable answer, said answer generation module configured to determine that the answer is a suitable answer if the LLM module outputs a response to the suitable-answer-assessment prompt indicating that the answer is a suitable answer.

3. A computer-implemented chatbot according to claim 1, wherein each time the LLM module generates an output which is a plan to answer the user query, the answer generation module is configured to execute a self-critiquing process, whereby a critique-request instruction prompt is generated and input to the LLM module instructing the LLM module to determine if the output meets a suitability criteria, and if the LLM module generates an output indicative of the output not meeting the suitability criteria, the answer generation module is configured to perform a corrective action.

4. A computer-implemented chatbot according to claim 3, wherein the corrective action comprises restarting by inputting the initial prompt to the LLM module.

5. A computer-implemented chatbot according to claim 3, wherein the corrective action comprises generating an output indicating the user query has not been answered.

6. A computer-implemented chatbot according to claim 1, wherein the initial prompt generated by the prompt generation module includes an instruction for the LLM to generate a plan to answer the user query if necessary.

7. A computer-implemented chatbot according to claim 1, wherein the one or more APIs provide access to an internet search engine.

8. A method of generating a response using a computer-implemented chatbot, said method comprising:
generating an initial prompt based on a prompt template combined with a received user query, said prompt including information source data specifying one or more sources of factual information, said sources comprising one or more external databases and/or one or more APIs, conversation history data comprising information specifying a conversation history, and failed response data indicative of previous prompts which have failed to produce a satisfactory response;
inputting the initial prompt to a LLM to generate an output;
determining if the output is a plan to answer a user query, and if so,
a) retrieving relevant data from the one or more external database and/or one or more APIs specified in the information source data,
b) generating a further prompt for answering the user query and input the further prompt to the LLM;
c) repeating a) and b) until the output of the LLM provides a suitable response to the user query, then
outputting the response to the user query.

9. A method according to claim 8, further comprising determining if an answer to the user query is a suitable answer by:
generating a suitable-answer-assessment prompt including: the answer, the initial user query and an instruction for the LLM to determine if the answer is a suitable answer or not, and
determining that the answer is a suitable answer if the LLM outputs a response to the prompt indicating the answer is a suitable answer.

10. A method according to claim 8, further comprising, each time an output is generated which is a plan to answer the user query, executing a self-critiquing process, comprising
generating a critique-request instruction prompt instructing the LLM to determine if the output meets a suitability criteria;
inputting the critique-request instruction prompt to the LLM, and if, the LLM generates an output indicative of the output not meeting the suitability criteria,
performing a corrective action.

11. A method according to claim 10, wherein the corrective action comprises restarting the process by inputting the initial prompt to the LLM.

12. A method according to claim 10, wherein the corrective action comprises generating an output indicating the user query has not been answered.

13. A method according to claim 8, wherein the initial prompt includes an instruction for the LLM to generate a plan to answer the user query if necessary.

14. A method according to claim 8, wherein the one or more APIs provide access to an internet search engine.

15. A computer program providing instructions which when implemented on a computing device implements a method according to claim 8.
